(19) United States
(12) Patent Application Publication
(10) Pub. No.: US 2005/0144027 A1
(43) Pub. Date: Jun. 30, 2005

(54) Individual protective containers

(76) Inventors: Michael Scott Brunner, Roswell, GA (US); Christian Michael Trusock, Cumming, GA (US); Wanda Walton Jackson, Alpharetta, GA (US); Nefetari Bordain Murph, Tucker, GA (US)

Correspondence Address: KIMBERLY-CLARK WORLDWIDE, INC., 401 NORTH LAKE STREET, NEENAH, WI, 54956, US

(21) Appl. No.: 10/748,644

(22) Filed: Dec. 29, 2003

(51) Int. Cl. G06F 17/60

(52) U.S. Cl. 705/1

(57) ABSTRACT

A method is provided for selling a perishable-receiving premium container, the method including providing the container adjacent to a display of a perishable, wherein the container is adapted to be used by a consumer to place the perishable into the container; charging the consumer for the perishable; and charging the consumer for the container based on indicia on the container. In addition, a method is provided for offering a consumer a choice between disposable perishable-receiving containers, the method including providing a premium container adjacent to a perishable; providing a standard container adjacent to the perishable; allowing the consumer to choose between the standard and premium containers; and charging the consumer for the container chosen based on indicia on the container, wherein the charge for the premium container is greater than the charge for the standard container.

### BACKGROUND

This invention pertains to a method of selling individual protective containers primarily in a retail setting.

In a retail setting, for example a grocery store, a retailer often provides bags for its customers to use to enclose and carry, for example, produce. The bags provided by a retailer are typically simple, standard bags of paper or poly, and are located near their point of use, such as on rolls in the produce section. The retailer also usually provides some sort of closure device such as a wire tie.

### SUMMARY OF THE INVENTION

The problem with providing such bags is that a retailer typically provides such bags free as a service to its customers. As a result, the bags are relatively inexpensive and without any additional useful features beyond their innate capability to enclose a space. Such bags do little to extend the freshness of their contents, protect their contents, or anything beyond simply holding their contents.

To solve these problems, a new individual protective container is required. The present invention overcomes these problems by providing a method for selling a perishable-receiving premium container, the method including providing the container adjacent to a display of a perishable, wherein the container is adapted to be used by a consumer to place the perishable into the container; charging the consumer for the perishable; and charging the consumer for the container based on indicia on the container.

The present invention also provides a method for offering a consumer a choice between disposable perishable-receiving containers, the method including providing a premium container adjacent to a perishable; providing a standard container adjacent to the perishable; allowing the consumer to choose between the standard and premium containers; and charging the consumer for the container chosen based on indicia on the container, wherein the charge for the premium container is greater than the charge for the standard container.

The present invention also provides a method for selling disposable perishable-receiving premium containers, the method including providing a first container adjacent to a first perishable, wherein the first container is adapted to be used by a consumer to place the first perishable into the first container, and wherein the first container has a first element-control feature; providing a second container adjacent to a second perishable, wherein the second container is adapted to be used by the consumer to place the second perishable into the second container, and wherein the second container has a second element-control feature; allowing the consumer to choose between the first and second containers; and charging the consumer for the container chosen based on the indicia on the container chosen.

The present invention also provides a method for producing a perishable-receiving premium container, the method including manufacturing a plurality of premium containers, wherein each premium container includes an element-control feature and an indicia of the price of the container; and assembling the plurality of premium containers to facilitate dispensing to a consumer and/or a retail worker.

The present invention also provides a disposable perishable-receiving container including an element-control feature, wherein the element to be controlled is selected from the group consisting of humidity, temperature, physical impact, odor, microbes, liquid leakage, liquid, gas mix, airflow, excess oil, and light; an indicia related to the container indicative of a price of the container, wherein the indicia is selected from the group consisting of a chip, an electronically-based indicator, a magnetically-based indicator, a produce-type number, a model number, a color, and a container shape; and a resealing device.

Other objects and advantages of the present invention will become more apparent to those skilled in the art in view of the following description and the accompanying drawings.

### BRIEF DESCRIPTION OF THE DRAWINGS

FIG. 1 is a schematic representation of an individual protective container system of the present invention.

FIG. 2 is a flowchart representation of the use of the individual protective container system of FIG. 1.

### DETAILED DESCRIPTION OF THE PREFERRED EMBODIMENTS

The invention described herein is an individual protective container system. Such a system allows a consumer to choose an individual protective container to meet the consumer's individual needs.

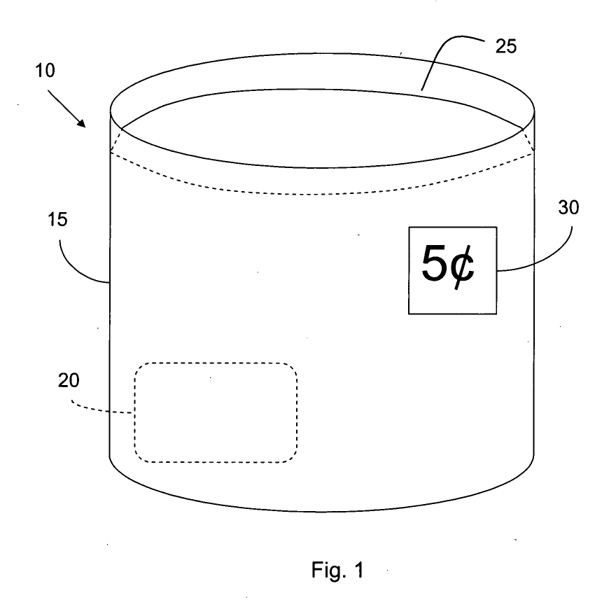

FIG. 1 illustrates an example of an individual protective container system 10 of the present invention. The system 10 includes a primary individual protective container or premium container 15 and an element-control feature 20. The individual protective container system 10 may include any type of individual protective or premium container 15, including, but not limited to, bags, bowls, and storage containers made from paper, film, or any suitable type of plastic. For purposes of illustration, and not for purposes of limitation, the individual protective container system 10 is described as it would apply to a poly or plastic bag. The same system 10, however, may be described using another suitable individual protective container.

The primary use of a premium container 15 is as a disposable perishable-receiving premium container, useable primarily in a retail setting such as a grocery store or restaurant. The premium container 15 may be available directly to the consumer for use, for example, in the produce section of the grocery store. The premium container 15 may also be available for use by a retail worker serving a consumer, as in the delicatessen section of a grocery store or in a restaurant for use by the retail worker in packaging foodstuffs selected by a consumer. The premium container 15 may be used in any setting in which a disposable container can be used to package a perishable substance. Settings may include, but are not limited to, grocery stores, delicatessens, florists, restaurants, quick-serve restaurants, butcher shops, gardening stores, and the like. Likewise, perishable substances may include, but are not limited to, foodstuffs, flowers, plants, and the like. For purposes of illustration, and not for purposes of limitation, the individual protective container system 10 is first described as it would be used with foodstuffs in the produce section of a grocery store. The same system 10, however, may be described as it would be used in any other suitable setting or with any other suitable perishable.

In the example described herein, the individual protective or premium container 15 is a poly or other plastic bag sized to accommodate whatever perishable item is expected to be placed within the bag. As an example, the premium container 15 may be similar in size to bags supplied in produce sections of grocery stores for a consumer's use in packaging produce.

Although the specific structure of the premium container 15 is not essential to the invention described herein, the premium container 15 is a premium-type container incorporating more features than a standard poly bag typically offered in the produce section of a grocery store. The standard bag is typically of thin denier, clear, inexpensively-made, includes no closure mechanism, and is typically offered by a retailer at no cost. Like the standard bag, the premium container 15 is capable of containing a perishable item, and is capable of being closed by some means. In the preferred embodiment, the premium container 15 may be closed by a resealing device 25 such as a zipper-type resealing device. The premium container 15 may also be closed by any other suitable closing device, including a plastic clip or a wire tie.

The individual protective container system 10 may also include one or a variety of element-control features 20. Each of these element-control features 20 performs at least one primary function such as controlling humidity; temperature; physical impact; odor; microbes; liquid leakage; liquid within the premium container 15; ripening through control of the gas mix, particularly ethylene, within the premium container 15; airflow, particularly of carbon dioxide and oxygen; light; excess oil; or any other controllable element. Element-control features 20 may be included singly or in combination in a premium container 15. For example, the premium containers 15 used for produce may be different from those in a delicatessen section. Different premium containers 15 may be used for fruits and for vegetables. Different premium containers 15 may also be used for citrus and other fruits. Any single or combination of element-control features 20 may be incorporated in a premium container 15 based on the desired and targeted use of the premium container 15.

While the element-control features 20 may take any suitable form or function, a variety of examples are described herein for use in the premium container 15. The following element-control features 20 are among those that may be used in a premium container 15:

A humidity control feature may be used to maintain a desired humidity within the premium container 15. The humidity control feature may tend to either increase or decrease the humidity within the premium container 15 as desired to optimize the storage of the intended perishable item. For example, a premium container 15 for certain types of fruit may seek to limit the humidity within the premium container 15, while a premium container 15 for certain types of vegetables may seek to increase the humidity within the premium container 15.

A microbe control feature may be used to control the proliferation of microbes such as bacteria within the premium container 15. For example, a microbe control feature that generates chlorine dioxide gas within the premium container 15 may be used to limit the growth of spoilage-causing bacteria within the premium container 15.

The individual protective container system 10 described herein allows the same or different manufacturers to produce the premium containers 15 and the standard poly bags.

In addition, the premium container 15 also includes an indicia 30 related to the premium container 15, where the indicia 30 is directly or indirectly indicative of a price of the premium container. The indicia 30 may be a bar code, a chip, a smart tag, an electronically-based indicator, a magnetically-based indicator, a price tag, a fruit sticker/produce-type number, a model number, a color, a container shape, a SKU, or any other suitable indicia.

Produce, such as fruits and vegetables, typically includes what is commonly referred to as a fruit label or a fruit sticker. The fruit sticker on a particular type of produce includes a number or price look-up (PLU) code commonly assigned to that particular type of produce. The PLU code assists a checker in identifying the item. For example, the fruit sticker on a banana includes the PLU code 4011, the number commonly assigned to bananas. A fruit-sticker type PLU code may also be commonly assigned to premium containers 15 as the indicia 30. Such a code may be printed directly on the premium container 15, placed on the premium container 15 with a sticker, or included with the premium container 15 by any suitable method. For example, a premium container 15 with a humidity-control feature may be assigned a PLU code of 6001, while a premium container 15 with an odor-control feature may be assigned a PLU code of 6002.

Bar codes, SKUs, and price tags are known in the art. One of these may be used in conjunction with a premium container 15 to indicate the price of the premium container 15, usually separate from any price indicator associated with the contents of the premium container 15.

Chips, smart tags, and any suitable electronically-based or magnetically-based indicators, and the like, may be used to indicate the price of a premium container 15. Again, such indication may be separate from any price indicator associated with the contents of the premium container 15.

Other suitable indicia 30 including a model number, a color, and a container shape may be used to assist a checker in associating a price with a particular premium container 15. For example, a particular style of premium container 15 may be assigned and labeled with a model number such as model 1. A checker will see the model number on the premium container 15 and know that a certain price is associated with that premium container 15. In another example, a premium container 15 with predominant or at least conspicuous blue indicia 30 may be assigned one price, while a premium container 15 with predominant or at least conspicuous red indicia 30 may be assigned a second price. In another example, a small, elongated premium container 15 may be assigned one price, while a large, square premium container 15 may be assigned a second price.

A primary purpose of premium container indicia 30 is to indicate to a consumer, a checker, a retail worker, a cash register, a computer, or other that a price is associated with that premium container 15. The indicia 30 may be associated with a premium container 15 by printing on the premium container 15, applying a label to the premium container 15, manufacturing the premium container 15 to include the indicia 30, by manufacturing the premium container 15 with a particular feature such as shape or size, or by any other suitable method.

Another primary purpose of premium container indicia 30 is to indicate to a consumer or other that a premium container 15 includes a particular element-control feature 20. The indicia 30 may indicate the presence of one or more element-control features 20, or may indicate the targeted use of the premium container 15, or both. For example, a premium container 15 that includes a microbe control feature may be labeled as such. In another example, a premium container 15 that includes a humidity control feature may be labeled as having a humidity control feature, or may be labeled simply as useful for citrus fruit, or both.

Premium containers 15, particularly if they are in a bag-like form, may be produced and provided on a roll, similar to the rolls of poly bags available in many retail produce sections. A plurality of premium containers 15 may also be placed on a wicket to enhance the ease of dispensing to a consumer. The premium containers 15 may also be provided in a box, in a pull-out or pop-up dispenser, in a stack, or by any other suitable means, and mounted or placed near the position at which they are needed. Any other suitable means for making premium containers 15 available to a consumer or a worker may be employed.

Each separate premium container 15 or collection of premium containers 15 may include a description of the intended uses of the premium containers 15 to instruct potential users. The descriptions may be placed on each premium container 15, on the packaging for the collection of premium containers 15, near the premium containers 15, or some combination of these. The descriptions may allow a consumer to become educated as to the conditions that typically dictate the use of a premium container 15, and/or to the results to be expected from use of the premium container 15. Such education allows a consumer to make informed decisions as to which premium container 15 to use and/or purchase to address various conditions.

Consumer education may be further enhanced by providing indicia 30 on the premium container 15 to indicate various different but associated components of the individual protective container system 10. The indicia 30 may include graphic design features, text, branding, or any other suitable indicia. For example, all of the premium containers 15 may exhibit similar graphic design components and branding to identify their association, yet have different coloring and illustrations to identify their differences. These indicia 30 may help a consumer to quickly discern which premium containers 15 may be needed for a particular purpose.

In other words, the individual protective container system 10 described herein allows a consumer to select a customized premium container 15 on an as-needed basis to address whatever products the consumer may be buying, or whatever circumstances the consumer may be facing, without spending more every day for an individual protective container 15 that contains every enhancement. Consumers desire a high quality, consistent product at a good price with the ability to have a customized premium container 15 for certain circumstances.

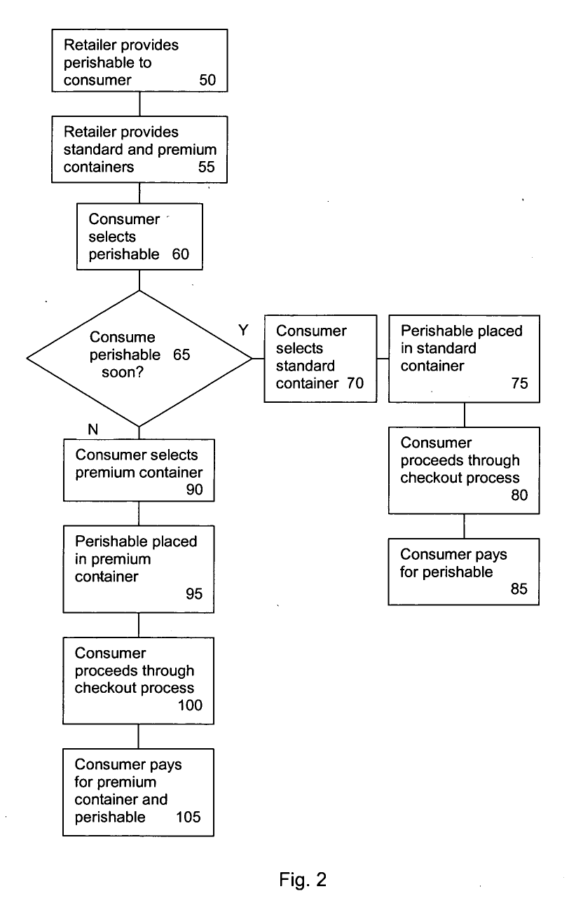

In use, and referring to FIG. 2, a grocer or other makes a perishable 50 and premium containers 15 available to consumers or workers 55 as on optional alternative to standard bags that are typically provided without cost. In other words, the grocer provides standard poly bags free of charge for consumer use 55. The grocer will also supply premium containers 15 as an alternative 55, and charge a nominal amount for each premium container 15. The premium containers 15 will offer an added feature or added features, particularly an element-control feature 20, desirable to the consumer to justify the additional cost.

The grocer places the premium containers 15, and optionally standard bags as well, near perishable items 55. The perishable item may be a foodstuff such as produce, deli, fast food, frozen food, baked goods, meat, or fish 50. The perishable item may also be any other suitable item described herein. A consumer selects a perishable 60 and decides which option to select based on the consumer's needs 65. If the consumer will be using the perishable item in short order, the consumer will likely select a standard bag 70. If the consumer desires additional features that will assist in preserving the perishable item for a longer time, the consumer can select the premium container 90. In the former case, the consumer places the perishable item in the standard bag 75, and seals the bag. When the consumer proceeds through check-out 80, the checker enters the perishable item into the cash register system, and the consumer pays for the perishable 85.

For example, a flowering plant may have a bar code label on its pot; the bar code is scanned by the checker, causing the register to access the store's database and assign a price to the plant. In another example, a bunch of bananas has thereon what is commonly referred to as a fruit label or a fruit sticker. The sticker includes the PLU code 4011, the code commonly assigned to bananas. The checker places the bananas on a scale, and enters the PLU code number. The register associates a price per pound with the PLU code, multiplies by the weight of the bananas, and determines a price for the bananas. If the produce is within a standard poly bag, the checker examines the PLU code through the bag.

For the case in which the consumer selects a premium container 90, the process is much the same, but adds an additional step. The consumer selects the premium container 90, and places the perishable in the premium container 95. The checker enters the PLU code and weighs the produce 100. The register calculates a price for the produce. The checker also causes the register to add the price of the premium container 15. For example, if the premium container 15 carries a bar code as an indicia 30, the checker then scans the bar code, causing the register to add in the price of the premium container 15. The consumer then pays for both the perishable and the premium container 105

In another example of use, a restaurateur or other makes premium containers 15 available to consumers or workers as on optional alternative to standard bags that are typically provided without cost 55. In other words, the restaurateur provides standard paper bags or foam containers free of charge to contain a consumer's order. The restaurateur will also supply premium containers 15 as an alternative, and charge a nominal amount for each premium container 15. The premium containers 15 will offer an added feature or added features, particularly an element-control feature 20, desirable to the consumer to justify the additional cost. For example, the premium container 15 may allow the consumer to purchase quick-serve food during the afternoon for actual consumption hours later at dinnertime. The consumer orders food 60, and is given a choice of a free standard container or a nominally-priced premium container 65. Because the consumer plans to consume the food hours later, the consumer selects the premium container 90 with at least one element-control feature 20, allowing the food to stay fresh for hours.

The restaurateur places the premium containers 15, and optionally standard containers as well near the perishable items, near the sales counter, or in any other place reasonably accessible to restaurant workers. The restaurant workers offer a choice of containers to the consumer 55. The consumer decides which option to select based on the consumer's needs 65. If the consumer will be using the perishable item in short order, the consumer will likely select a standard container 70. If the consumer desires additional features that will assist in preserving the perishable item for a longer time, the consumer can select the premium container 90. In the former case, the perishable item is placed in the standard bag 75. The consumer proceeds to check out 80 and pays for only the perishable item 85.

For the case in which the consumer selects the premium container 15, the process is much the same, but adds an additional step. The restaurant worker or the consumer places the perishable item in the premium container 95, and the restaurant worker enters the perishable item into a register or other 100. The register calculates a price for the perishable item. The checker also causes the register to add the price of the premium container 15. For example, if in a quick-serve restaurant, the restaurant worker presses a button on the register for hamburger, another for French fries, and a third for the premium container 15. The restaurant worker knows the container is a premium container 15 because of indicia 30 on the premium container 15. The consumer then pays for both the perishable item and the premium container 105.

Again, the individual protective container system 10 described herein allows a consumer to select a premium container 15 with only particular element-control features 20 on an as-needed basis to address whatever products the consumer may be buying, or whatever circumstances the consumer may be facing, without spending more every day for a premium container 15 that contains every enhancement or element-control feature 20. For a nominal additional cost, a consumer can maintain the freshness of purchased perishable items far longer than is possible with standard containers, if desired. Consumers desire a high quality, consistent product at a good price with the ability to have a customized premium container 15 for certain circumstances.

Other objects and advantages of the present invention will become more apparent to those skilled in the art in view of the following description and the accompanying drawings.

The invention has been described with reference to various specific and illustrative embodiments and techniques. However, it should be understood that many variations and modifications may be made while remaining within the spirit and scope of the invention. Many alternatives, modifications and variations will be apparent to those skilled in the art in light of the foregoing description. Accordingly, this invention is intended to embrace all such alternatives, modifications, and variations that fall within the spirit and scope of the appended claims.

1. A method for selling a perishable-receiving premium container, the method comprising:
providing the container adjacent to a display of a perishable, wherein the container is adapted to be used by a consumer to place the perishable into the container;
charging the consumer for the perishable; and
charging the consumer for the container based on indicia on the container.

2. The method of claim 1, further comprising providing a perishable, wherein the perishable is of a type selected from the group consisting of produce, deli, fast food, quick-serve food, frozen food, baked goods, meat, fish, and floral.

3. The method of claim 1, further comprising controlling an element with the premium container, wherein the element is selected from the group consisting of humidity, temperature, physical impact, odor, microbes, liquid leakage, liquid, gas mix, airflow, excess oil, and light.

4. The method of claim 1, further comprising providing indicia related to the container indicative of a price of the container, wherein the indicia is selected from the group consisting of a bar code, a chip, a smart tag, an electronically-based indicator, a magnetically-based indicator, a price tag, a produce-type number, a model number, a color, a container shape, and a SKU.

5. The method of claim 1, wherein the container is resealable.

6. The method of claim 1, wherein the providing step includes providing a plurality of the containers.

7. The method of claim 1, wherein the providing step includes providing the container on a wicket.

8. The method of claim 1, wherein the providing step includes providing the container on a roll.

9. The method of claim 1, wherein the providing step includes providing the container in a box.

10. The method of claim 1, wherein the container is disposable.

11. The method of claim 1, further comprising allowing a consumer to place the perishable into the container and to seal the container.

12. A method for offering a consumer a choice between disposable perishable-receiving containers, the method comprising:
providing a premium container adjacent to a perishable;
providing a standard container adjacent to the perishable;
allowing the consumer to choose between the standard and premium containers; and
charging the consumer for the container chosen based on indicia on the container, wherein the charge for the premium container is greater than the charge for the standard container.

13. The method of claim 12, wherein the indicia is selected from the group consisting of a bar code, a chip, a smart tag, an electronically-based indicator, a magnetically-based indicator, a price tag, a produce-type number, a model number, a color, a container shape, and a SKU.

14. The method of claim 12, wherein the charge for the standard container is zero.

15. The method of claim 12, wherein the premium container has an element-control feature.

16. The method of claim 15, further comprising providing a consumer with information regarding the element-control feature of the premium container.

17. The method of claim 15, wherein the premium container has a plurality of element-control features.

18. A method for selling disposable perishable-receiving premium containers, the method comprising:
providing a first container adjacent to a first perishable, wherein the first container is adapted to be used by a consumer to place the first perishable into the first container, and wherein the first container has a first element-control feature;
providing a second container adjacent to a second perishable, wherein the second container is adapted to be used by the consumer to place the second perishable into the second container, and wherein the second container has a second element-control feature;
allowing the consumer to choose between the first and second containers; and
charging the consumer for the container chosen based on the indicia on the container chosen.

19. The method of claim 18, further comprising providing the consumer with information regarding the first and second element-control features.

20. The method of claim 18, wherein the first container has a plurality of element-control features.

21. A method for producing a perishable-receiving premium container, the method comprising:
manufacturing a plurality of premium containers, wherein each premium container includes an element-control feature and an indicia of the price of the container; and
assembling the plurality of premium containers to facilitate dispensing to a consumer and/or a retail worker.

22. The method of claim 21, wherein the plurality of premium containers are disposable.

23. A disposable perishable-receiving container comprising:
an element-control feature, wherein the element to be controlled is selected from the group consisting of humidity, temperature, physical impact, odor, microbes, liquid leakage, liquid, gas mix, airflow, excess oil, and light;
an indicia related to the container indicative of a price of the container, wherein the indicia is selected from the group consisting of a chip, an electronically-based indicator, a magnetically-based indicator, a produce-type number, a model number, a color, and a container shape; and
a resealing device.
